(19) United States
(12) Patent Application Publication
(10) Pub. No.: US 2025/0071474 A1
(43) Pub. Date: Feb. 27, 2025

(54) SPEAKER DEVICE

(71) Applicant: Tymphany HK Limited, Hong Kong (HK)

(72) Inventor: Wen-An HUANG, Taipei City (TW)

(21) Appl. No.: 18/790,370

(22) Filed: Jul. 31, 2024

Related U.S. Application Data
(60) Provisional application No. 63/578,864, filed on Aug. 25, 2023.

(51) Int. Cl. H04R 1/28; H04R 1/02

(52) U.S. Cl. CPC H04R 1/2888; H04R 1/025; H04R 1/2811

(57) ABSTRACT

A speaker device of the invention includes a speaker box, a sound generating module and a damping member. The speaker box includes a main body and a mounting hole formed on the main body, wherein the speaker box includes a front panel, a rear panel and a resonating chamber formed therebetween. The sound generating module is disposed in the mounting hole and extending into the resonating chamber, wherein the sound generating module vibrates back and forth in a vibrating direction to generate sound waves. The damping member is disposed on the front panel and/or the rear panel of the main body, wherein the damping member has an axial direction perpendicular to the vibrating direction. The damping member is rod-shaped and includes a core and an enclosure enclosing the core, the core has a stiffness greater than that of the enclosure.

### CROSS-REFERENCE TO RELATED APPLICATIONS

This application claims an invention which was disclosed in Provisional Application No. 63/578,864, filed Aug. 25, 2023, entitled “Damping system for speaker module”. The benefit under 35 USC § 119(e) of the United States provisional application is hereby claimed, and the aforementioned application is hereby incorporated herein by reference.

### BACKGROUND OF THE INVENTION

### Field of the Invention

The invention relates to a technical field of speaker device, and more particularly to a speaker device provided with damping members on a speaker box.

### Description of the Related Art

The speaker device is a device configured to receive audio signals and convert the audio signals into sound waves. The speaker device includes a speaker box and a sound generating module mounted on a front panel of the speaker box. The sound generating module receives the audio signals and generates mechanical vibration in accordance with the audio signals, which causes vibration of air and thus generates sound waves. The sound waves give off and move forwards from the speaker box. For certain speaker devices enhanced in sound (such as mega bass sound), a phase inverted tube is equipped in addition to the speaker box and the sound generating module. Air vibration generated in the phase inverted tube and the speaker box resonate, whereby the sound waves in the speaker box propagate to external environment through the phase inverted tube and overlap with the sound waves originally moving forwards from the speaker box to enhance sound (such as mega bass sound).

As the sound waves are air vibration caused by the mechanical vibration of the sound generating module, the air vibration in the speaker box may cause vibration of the speaker box itself, particular for the speaker device enhanced by mega bass sound. The vibration of the speaker box itself causes additional vibration of air and noise is thus generated.

### BRIEF SUMMARY OF THE INVENTION

An object of the present invention is to provide a speaker device solving the problem of noise cause by the vibration of the speaker box itself due to the sound.

The invention provides a speaker device. The speaker device in accordance with an exemplary embodiment of the invention includes a speaker box, a sound generating module and a damping member. The speaker box includes a main body and a mounting hole formed on the main body, wherein the speaker box includes a front panel, a rear panel and a resonating chamber formed therebetween. The sound generating module is disposed in the mounting hole and extending into the resonating chamber, wherein the sound generating module vibrates back and forth in a vibrating direction to generate sound waves. The damping member is disposed on the front panel and/or the rear panel of the main body, wherein the damping member has an axial direction perpendicular to the vibrating direction. The damping member is rod-shaped and includes a core and an enclosure enclosing the core, the core has a stiffness greater than that of the enclosure.

In another exemplary embodiment, the speaker device further includes a plurality of damping members, wherein the mounting hole is formed on the front panel, at least one of the damping members is disposed in vicinity of the front panel, and at least one of the damping members is disposed in vicinity of the rear panel.

In yet another exemplary embodiment, the speaker device further includes at least one holding member extending along the vibrating direction and connects the front panel and the rear panel.

In another exemplary embodiment, the holding member includes a plurality of insertion holes formed at two opposite sides thereof, and one end of the core of the damping member is inserted into the insertion hole.

In yet another exemplary embodiment, the speaker device further includes a phase-inverted tube disposed in the resonating chamber, the speaker box further includes a phase-inverted hole formed on the rear panel, and one end of the phase-inverted tube communicates with the phase-inverted hole.

In another exemplary embodiment, the main body includes a first body and a second body, the first body and the second body have different depth defined by a distance between the front panel and the rear panel, the mounting hole and the phase-inverted hole are formed on the first body, and the other end of the phase-inverted tube is located in the second body.

In yet another exemplary embodiment, the main body further includes two first structural grooves extending along the vibrating direction and formed on two opposite sides of connection of the first body and the second body, whereby the connection of the first body and the second body is neck-shaped.

In another exemplary embodiment, the main body further includes two second structural grooves extending along the vibrating direction and formed at one side of the first body away from the second body.

In yet another exemplary embodiment, the main body further includes two third structural grooves extending along the vibrating direction and formed at one side of the second body away from the first body.

In another exemplary embodiment, connection of the first box and the second box is step-structured, and a center of the first box and a center of the second box is unaligned.

In yet another exemplary embodiment, the damping members are disposed on the front panel and located at two opposite sides of the mounting hole of the first body in such a manner that each side thereof is provided with at least one of the damping members, the damping members are disposed on the rear panel and located at two opposite sides of the phase-inverted hole in such a manner that each side thereof is provided with at least one of the damping members.

In another exemplary embodiment, at least one of the damping members is disposed on one side of the front panel at the second body away from the mounting hole.

In yet another exemplary embodiment, the speaker box further includes at least one mounting groove formed on the front panel and/or the rear panel and extending along a direction perpendicular to the vibrating direction, the damping member is disposed in the mounting groove.

In another exemplary embodiment, the speaker box further includes a plurality of engaging tabs disposed in the mounting groove, the damping member further includes a plurality of limiting flanges disposed on the enclosure, the enclosure engages the engaging tabs in an axial constrained manner that each of the engaging tabs is clamped by two of the limiting flanges.

As the speaker box is provide with damping members, the damping members are capable of reducing the vibration of the speaker box and even completely eliminating it when the sound waves generated in the resonating chamber of the speaker box, whereby the additional noises caused by the vibration of the speaker box are prevented.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a perspective view of an embodiment of a speaker device of the present invention;

FIG. 2 is a perspective view of the speaker device of FIG. 1 in another view angle;

FIG. 3 is an exploded view of the speaker device of FIG. 1;

FIG. 4 is a top view of the speaker device of FIG. 1;

FIG. 5 is a cross section along line A-A of FIG. 4;

FIG. 6 is a cross section along line B-B of FIG. 4; and

FIG. 7 is a perspective view of an embodiment of a damping member of the speaker device of FIG. 1.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

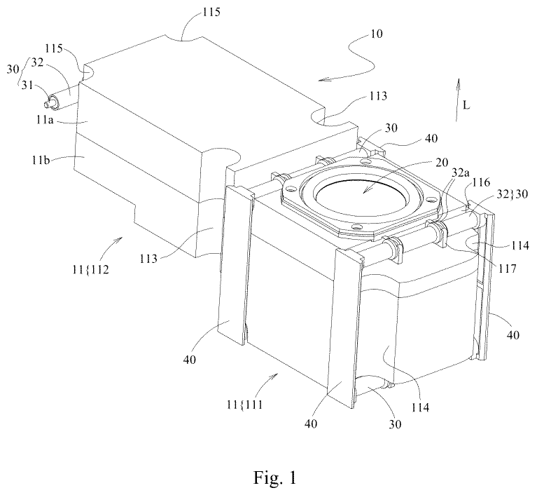

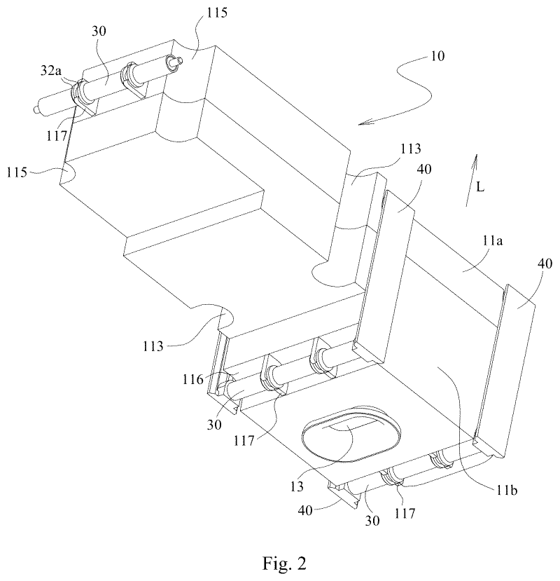

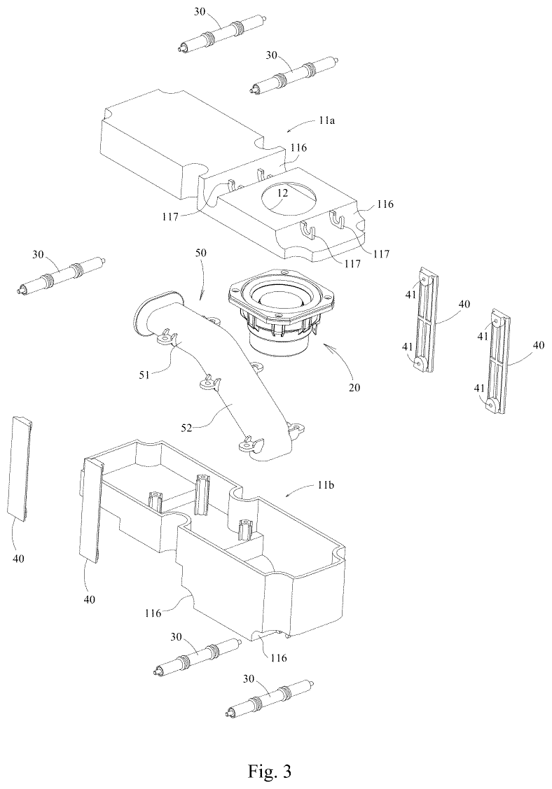

Referring to FIGS. 1, 2 and 3, an embodiment of a speaker device of the present invention is disclosed. The speaker device 1 of the present invention includes a speaker box 10, a sound generating module 20, a plurality of damping members, a plurality of holding members 40 and a phase-inverted tube 50. The sound generating module 20 is disposed at one side of the speaker box 10. The damping members 30 are disposed at a plurality of positions of the speaker box 10. Each of the holding member 40 connects two damping members 30 to increase stiffness of the connection structure. The phase-inverted tube 50 is disposed in the speaker box 10 for enhancement of sound (such as mega bass sound).

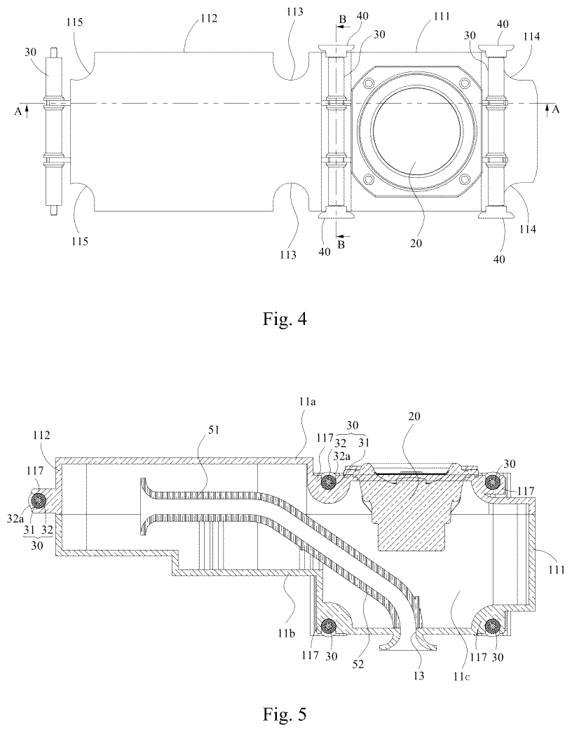

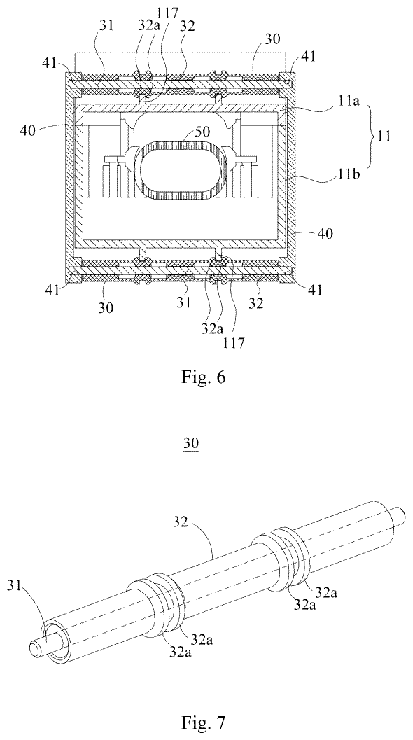

Referring to FIGS. 4, 5 and 6, the speaker box 10 includes a main body 11, a mounting hole 12 and a phase-inverted hole 13. The main body 11 is assembled by a front panel 11a and a rear panel 11b. A resonating chamber 11c is formed between the assembled front panel 11a and the rear panel 11b. The main body 11 includes a first body 111 and a second body 112. The first body 111 and the second body 112 have chambers communicated with each other and thus forming the resonating chamber 11c.

The first body 111 and the second body 112 are equally-sized in width, but the first body 111 has a depth greater than that of the second body 112, whereby connection of the first body 111 and the second body 112 is step-structured, and centers of the first body 111 and the second body 112 are unaligned. The center of the second body 112 has a position higher than that of the center of the first body 111. The aforementioned depth is defined as a distance between the front panel 11a and the rear panel 11b. The second body 112 has a length greater than that of the first body 111. The portion of the front panel 11a corresponding to the second body 112 is higher than the portion of the front panel 11a corresponding to the first body 111, whereby the front panel 11a is step-structured. Similarly, the portion of the rear panel 11b corresponding to the second body 112 is higher than the portion of the rear panel 11b corresponding to the first body 111, whereby the rear panel 11b is step-structured.

The speaker body 11 further includes two first structural grooves 113, two second structural grooves 114 and two third structural grooves 115. The first structural grooves 113 are curved in cross section and formed at the connection of the first body 111 and the second body 112, whereby the connection of the first body 111 and the second body 112 is neck-structured. The second structural grooves 114 are curved in cross section and formed at one side of the first body 111 away from the second body 112. The third structural grooves 115 are curved in cross section and formed at one side of the second body 112 away from the first body 111. The first structural grooves 113 formed at the connection of the first body 111 and the second body 112, and the second structural grooves 114 and the third structural grooves 115 are formed at two opposite sides of the main body 11.

The mounting hole 12 is formed on a portion of the front panel 11a corresponding to the first body 111, and the phase inverted tube 13 is formed on a portion of the rear panel 11b corresponding to the first body 111. The sound generating module 20 is disposed in the mounting hole 12 and extends to the resonating chamber 11c. Current flows through a coil to move a diaphragm forward and backward along a vibrating direction L perpendicular to the front panel 11a, thereby generating sound waves. The sound waves give off from the main body 11 and move forward. The sound waves in the speaker box 10 propagate through the phase-inverted tube 50 and give off from the phase-inverted hole 13 to an external environment. The sound waves from the phase-inverted hole 13 overlaps the sound waves originally moving forwards from the speaker box 10 to enhance sound (such as mega bass sound).

The phase-inverted tube 50 extend across the first body 111 and the second body 112. One end of the phase-inverted tube 50 is communicated with the phase-inverted hole 13, and the other end of the phase-inverted tube 50 is located in the second body 112. The phase-inverted tube 50 has a horizontal section 51 and an inclined section 52, wherein the horizontal section 51 is located in the second body 112, and the inclined section 52 extends from the second body 112 to the first body 111 and communicates with the phase-inverted hole 13. A horn structure is formed at the end of the phase-inverted tube 50 at a surface of the second body 112.

The damping members 30 are disposed at the front panel 11a and/or the rear panel 11b. The damping members 30 has an axial direction perpendicular to the vibrating direction L. Two mounting grooves 116 are formed on the front panel 11a, and each side of the mounting hole 12 is provided with one mounting groove 116. Two mounting grooves 116 are formed on the rear panel 11b, and each side of the phase-inverted hole 13 is provided with one mounting groove 116. The mounting groove 116 has a curved cross section and extend along a direction perpendicular to the vibrating direction L. A plurality of engaging tabs 117 are disposed in the mounting groove 116. The damping member 30 is positioned in the mounting groove 116 through the engagement of the damping member 30 with the engaging tabs 117.

Referring to FIG. 7, the damping member 30 is rod-shaped, and includes a core 31 and an enclosure 32 enclosing the core 31. The core 31 is a metal rod, and the enclosure 32 is made of plastic material. The core 31 has a stiffness greater than that of the enclosure 32. A plurality of limiting flanges 32 is disposed at an outer peripheral surface of the enclosure 32. The limiting flanges 32 are annular. The damping members 30 are disposed in the mounting groove 116 in such a manner that the engaging tabs 117 engage an outer peripheral surface of the enclosure 32, and the adjacent limiting flanges 32a clamp the engaging tabs 117, whereby the damping member 30 is constrained by the engaging tabs 117 and the limiting flanges 32a in three orthogonal directions.

As each of the opposite sides of the mounting hole 12 is provided with a mounting groove 116 on the front panel 11a, and each of the opposite sides of the phase-inverted hole 13 is provided with a mounting groove 116 on the rear panel 11b, therefore, each of opposite sides of the mounting hole 12 is provided with a damping member 30, and each of opposite sides of the phase-inverted hole 13 is provided with a damping member 30. Each of the holding members 40 connects a damping member 30 on the front panel 11a and a damping member 30 on the rear panel 11b. As the holding member 40 connects the damping members 30 at two positions, the damping members 30 at two positions are integrated through the holding member 40, whereby the stiffness of the speaker box 10 along the vibrating direction L is further increased. The holding member 40 includes insertion holes 41 at two opposite ends, into which the core 31 of the damping member 30 is inserted.

A plurality of the engaging tabs 117 are also disposed at one end of the second body 112 away from the first body 111, and a damping member 30 is disposed at the end of the second body 112 away from the first body 111.

The first structural grooves 113, the second structural grooves 114 and the third structural grooves 115 extending along the vibrating direction L are capable of increase the stiffness of the speaker box 10.

As the speaker box is provide with damping members, the damping members are capable of reducing the vibration of the speaker box and even completely eliminating it when the sound waves generated in the resonating chamber of the speaker box, whereby the additional noises caused by the vibration of the speaker box are prevented.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A speaker device, comprising:
a speaker box comprising a main body and a mounting hole formed on the main body, wherein the speaker box comprises a front panel, a rear panel and a resonating chamber formed therebetween;
a sound generating module disposed in the mounting hole and extending into the resonating chamber, wherein the sound generating module vibrates back and forth in a vibrating direction to generate sound waves;
a damping member disposed on the front panel and/or the rear panel of the main body, wherein the damping member has an axial direction perpendicular to the vibrating direction;
wherein the damping member is rod-shaped and comprises a core and an enclosure enclosing the core, the core has a stiffness greater than that of the enclosure.

2. The speaker device as claimed in claim 1, further comprising a plurality of damping members, wherein the mounting hole is formed on the front panel, at least one of the damping members is disposed in vicinity of the front panel, and at least one of the damping members is disposed in vicinity of the rear panel.

3. The speaker device as claimed in claim 2, further comprising at least one holding member extending along the vibrating direction and connects the front panel and the rear panel.

4. The speaker device as claimed in claim 3, wherein the holding member comprises a plurality of insertion holes formed at two opposite sides thereof, and one end of the core of the damping member is inserted into the insertion hole.

5. The speaker device as claimed in claim 2, further comprising a phase-inverted tube disposed in the resonating chamber, the speaker box further comprises a phase-inverted hole formed on the rear panel, and one end of the phase-inverted tube communicates with the phase-inverted hole.

6. The speaker device as claimed in claim 5, wherein the main body comprises a first body and a second body, the first body and the second body have different depth defined by a distance between the front panel and the rear panel, the mounting hole and the phase-inverted hole are formed on the first body, and the other end of the phase-inverted tube is located in the second body.

7. The speaker device as claimed in claim 6, wherein the main body further comprises two first structural grooves extending along the vibrating direction and formed on two opposite sides of connection of the first body and the second body respectively, whereby the connection of the first body and the second body is neck-shaped.

8. The speaker device as claimed in claim 7, wherein the main body further comprises two second structural grooves extending along the vibrating direction and formed at one side of the first body away from the second body.

9. The speaker device as claimed in claim 7, wherein the main body further comprises two third structural grooves extending along the vibrating direction and formed at one side of the second body away from the first body.

10. The speaker device as claimed in claim 6, wherein connection of the first box and the second box is step-structured, and a center of the first box and a center of the second box is unaligned.

11. The speaker device as claimed in claim 6, wherein the damping members are disposed on the front panel and located at two opposite sides of the mounting hole of the first body in such a manner that each side thereof is provided with at least one of the damping members, the damping members are disposed on the rear panel and located at two opposite sides of the phase-inverted hole in such a manner that each side thereof is provided with at least one of the damping members.

12. The speaker device as claimed in claim 11, wherein at least one of the damping members is disposed on one side of the front panel at the second body away from the mounting hole.

13. The speaker device as claimed in claim 1, wherein the speaker box further comprises at least one mounting groove formed on the front panel and/or the rear panel and extending along a direction perpendicular to the vibrating direction, the damping member is disposed in the mounting groove.

14. The speaker device as claimed in claim 13, wherein the speaker box further comprises a plurality of engaging tabs disposed in the mounting groove, the damping member further comprises a plurality of limiting flanges disposed on the enclosure, the enclosure engages the engaging tabs in an axial constrained manner that each of the engaging tabs is clamped by two of the limiting flanges.
